(19) United States
(12) Patent Application Publication
(10) Pub. No.: US 2003/0148027 A1
(43) Pub. Date: Aug. 7, 2003

(54) Method and apparatus for forming coated units

(76) Inventor: Matthew J. Holcomb, Manhattan Beach, CA (US)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/351,041

(22) Filed: Jan. 24, 2003

Related U.S. Application Data
(60) Provisional application No. 60/355,740, filed on Feb. 5, 2002.
(60) Provisional application No. 60/360,285, filed on Feb. 27, 2002.
(60) Provisional application No. 60/371,811, filed on Apr. 10, 2002.
(60) Provisional application No. 60/379,137, filed on May 8, 2002.

(51) Int. Cl. B05D 7/00

(52) U.S. Cl. 427/212; 427/596; 118/58

(57) ABSTRACT

A method is provided for forming coated units. A bonding energy between agglomerated particles is overcome to separate the particles into deagglomerated units. Each unit may have one or more particles, and at least 50% of the units preferably have widths of less than 10 microns. A layer is then formed on at least some of the deagglomerated units to form a plurality of coated units. The coated units are then captured.

### CROSS-REFERENCE TO RELATED APPLICATIONS

Priority is claimed from U.S. Provisional Patent Applications No. 60/355,740, filed on Feb. 5, 2002; No. 60/360,285, filed on Feb. 27, 2002; No. 60/371,811, filed on Apr. 10, 2002; and No. 60/379,137, filed on May 8, 2002, all of which are incorporated herein by reference in their entirety.

### BACKGROUND OF THE INVENTION

This invention relates to an apparatus and method for forming small coated units.

### SUMMARY OF THE INVENTION

A method is provided for forming coated units. A bonding energy between agglomerated particles is overcome to separate the particles into deagglomerated units. Each unit may have one or more particles, and at least 50% of the units preferably have widths of less than 10 microns. A layer is then formed on at least some of the deagglomerated units to form a plurality of coated units. The coated units are then captured.

The bonding energy may be overcome by impact against a surface traveling relatively toward the agglomerated particles, preferably at a velocity of at least 1 m/s.

The surface may be a surface on a component traveling in a closed loop path, such as a tooth on a wheel, in which case the method may include the step of feeding the agglomerated particles to the surface so that successive amounts of the agglomerated particles are struck by the surface upon successive revolutions of the component.

The particles preferably have width of less than five microns.

The method may further include the steps of introducing the deagglomerated units into a gas, the gas having select pressure such that the deagglomerated units couple to the gas and travel with the gas in a select direction, and pumping the gas in a direction other than a direction in which the deagglomerated units travel, to de-couple the deagglomerated units from a majority of the gas before forming the layers on the deagglomerated units.

The pressure of the gas is preferably sufficiently low such that less than 10% of the deagglomerated units re-agglomerate before the gas is de-coupled from the deagglomerated units. The pressure of the gas is preferably between 0.05 and 0.5 Torr.

The flow of the gas is preferably laminar.

The pressure of the gas surrounding the deagglomerated units is preferably between 0.001 and 0.1 Torr after the deagglomerated units de-couple from the gas.

The method may further include the steps of allowing the deagglomerated units to travel through a skimmer, and allowing the deagglomerated units to travel from the skimmer into a coating chamber, the skimmer having a small width compared to the coating chamber which, in combination with a length of the skimmer, control a pressure in the coating chamber.

The deagglomerated units may be coated by a source of coating particles traveling transverse to a direction in which the deagglomerated units travel.

The method may further include the step of directing a laser beam onto an ablation target, ablated coating particles being released from the ablation target and traveling from the ablation target onto the deagglomerated units.

The deagglomerated units may be coated with the layers in a coating chamber which is at least partially formed by a window, and the laser beam may be directed through the window into the coating chamber and onto the ablation target.

The invention also provides an apparatus for forming coated units, comprising means for overcoming a bonding energy between agglomerated particles to separate the particles into deagglomerated units, each unit having one or more particles and at least 50% of the units having widths of less than 10 microns, means for forming a layer on at least some of the deagglomerated units to form a plurality of coated units, and means for capturing the coated units.

The invention further provides an apparatus for forming a plurality of coated units, comprising a feed system capable of holding and feeding agglomerated particles to a deagglomeration location, a component traveling in a closed loop path and having a surface that repeatedly strikes successive amounts of the agglomerated particles at the deagglomeration location to separate the particles into deagglomerated units, each unit having one or more particles, a coating chamber where a layer is formed on at least some of the deagglomerated units to form a plurality of coated units, and a device positioned to capture the coated units.

The apparatus may further include a deagglomeration chamber having a gas inlet and a gas outlet, and a vacuum device connected to the gas outlet, the deagglomerated units coupling to a gas traveling from the inlet to the outlet and de-coupling from the gas before the gas is pumped through the outlet and before being coated in the coating chamber.

The apparatus may further include a source of coating particles, coating particles traveling from the source transverse to a direction in which the deagglomerated units travel, and coating the deagglomerated units.

### BRIEF DESCRIPTION OF THE DRAWINGS

The invention is further described by way of examples with reference to the accompanying drawings, wherein:

FIG. 1 is a cross-sectional side view of an apparatus, according to an embodiment of the invention, used for forming coated units;

FIGS. 2A and 2B illustrate how a cluster of particles is deagglomerated by a deagglomerator forming part of the apparatus;

FIG. 3 is a graph illustrating deagglomeration efficiency for different particle sizes and impact speeds;

FIGS. 4A and 4B illustrate what occurs when a pressure within the deagglomerator is too low and when the pressure is too high, respectively;

FIGS. 5A and 5B illustrate what occurs when a pressure within a coating chamber is too high and too low, respectively;

FIG. 6 is a plan view illustrating an alternative coating system, wherein three lasers are used as opposed to the single laser of the apparatus of FIG. 1;

FIG. 7 is a cross-sectional side view illustrating the use of two lasers and two targets to form two layers on particles of the same or different materials;

FIG. 8 is a cross-sectional side view illustrating a coating system for an apparatus, according to a further embodiment of the invention, utilizing magnetron sputtering;

FIG. 9 is a cross-sectional plan view of the coating system of FIG. 8;

FIG. 10 is a cross-sectional side view of a coating system for an apparatus according to yet a further embodiment of the invention, utilizing an evaporated metal as coating particles; and

FIG. 11 is a cross-sectional side view of an apparatus, according to yet a further embodiment of the invention, which utilizes a mixture of particles that have to be coated and particles acting as a source for layers formed on the particles that are coated.

### DETAILED DESCRIPTION OF THE INVENTION

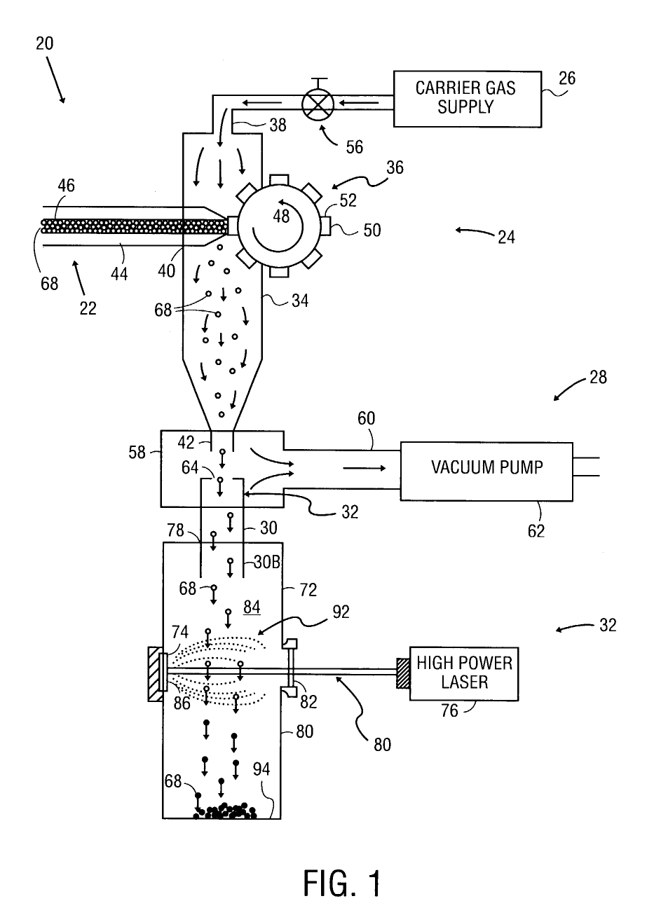

FIG. 1 of the accompanying drawings illustrates an apparatus 20, according to an embodiment of the invention, which includes a powder feed system 22, a deagglomerator 24, a carrier gas supply 26, a vacuum system 28, a skimmer 30, and a coating system 32.

The deagglomerator 24 includes a deagglomeration chamber 34, a deagglomeration wheel 36, and a deagglomeration motor (not shown). The deagglomeration chamber 34 has a gas inlet 38 at the top, a particle inlet 40 in a side thereof, and an outlet nozzle 42 at the bottom.

The powder feed system 22 includes a powder feed tube 44 that is inserted into the particle inlet 40 and has a feed passage 46 therethrough. The wheel 36 is mounted for rotation in a direction 48 by the motor. The wheel 36 has a plurality of teeth 50, and each tooth 50 has a respective impact surface 52 which is transverse to a direction of travel of the respective tooth 50. The feed passage 46 terminates at a center of the deagglomeration chamber 34. The teeth 50 rotate sequentially after one another past a terminating end of the feed passage 46. Each tooth 50 thus follows a closed loop path and repeatedly passes the terminating end of the feed passage 46.

The carrier gas supply 26 is connected through a valve 56 to the gas inlet 38. Opening of the valve 56 will place the carrier gas supply 26 in communication with the gas inlet 38. In addition, it is also possible to control an aperture of the valve 56 to control a flow rate of gas into the deagglomeration chamber 34.

The vacuum system 28 includes a vacuum chamber 58, a vacuum pipe 60, and a vacuum pump 62. The vacuum pipe 60 has one end that is connected to an opening in a side of the vacuum chamber 58. The vacuum pump 62 is connected to an opposing end of the vacuum pipe 60. Operation of the vacuum pump 62 will cause flow of gas from the vacuum chamber 58 through the outlet in the side thereof and through the vacuum pipe 60 and the vacuum pump 62.

The skimmer 30 is a tubular member having an orifice 64 at an upper end thereof. A lower end of the deagglomeration chamber 34 is inserted into a top wall of the vacuum chamber 58. An upper portion of the skimmer 30 is inserted into a bottom wall of the larger vacuum chamber 58. A central axis of the deagglomeration chamber 34 is aligned with a central axis of the skimmer 30. A gap is defined between the lower end of the deagglomeration chamber 34 and the orifice 64.

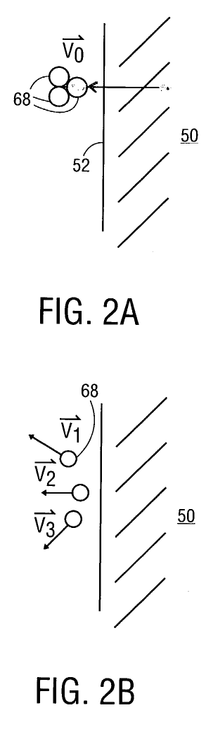

In use, clusters of agglomerated particles 68 are fed through the feed passage 46 to the deagglomeration wheel 36. Successive clusters leaving the feed passage 46 are struck by the impact surfaces 52 of successive ones of the teeth 50. FIGS. 2A and 2B illustrate one of the clusters that are struck by one of the teeth 50. A bonding energy keeps the particles 68 together (FIG. 2A). The impact by the tooth 50 overcomes the bonding energy that keeps the particles 68 together, so that the particles are broken apart (FIG. 2B).

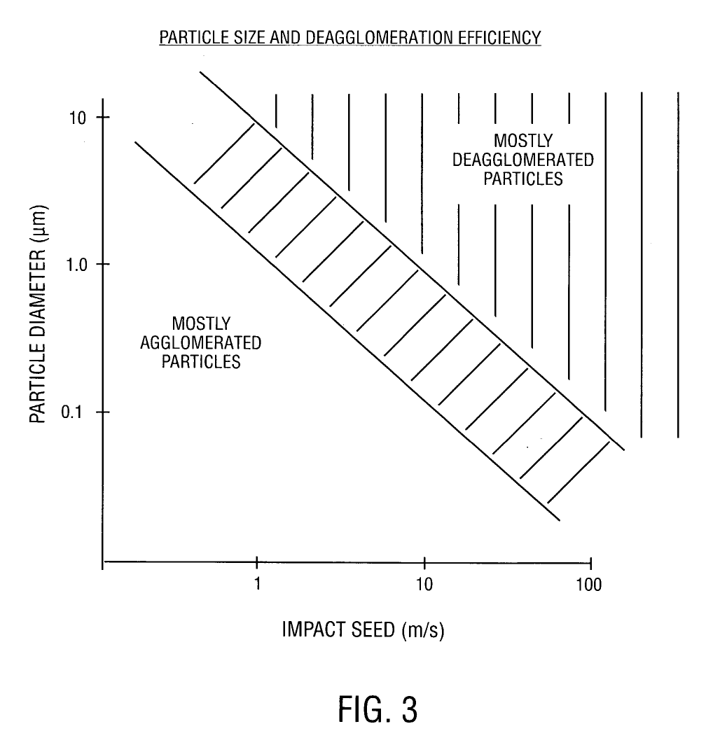

As illustrated in FIG. 3, the degree to which the clusters are broken apart depends on the sizes of the particles and the speed of impact. A larger speed of impact is required for smaller particles because of larger relative bonding energies between smaller particles. Generally speaking, an impact speed of at least 10 m/s is required for particles that are less than 10 microns in diameter. Preferably, the impact speed is sufficient such that at least 50% of the entire initial mixture is deagglomerated into units (individual particles or smaller clusters of particles) having widths of less than 10 microns. Approximately 2 g of agglomerated particles is processed within about five minutes. Further reference to “particles 68” herein should be understood to mean “units,” which may be individual particles or small clusters of particles.

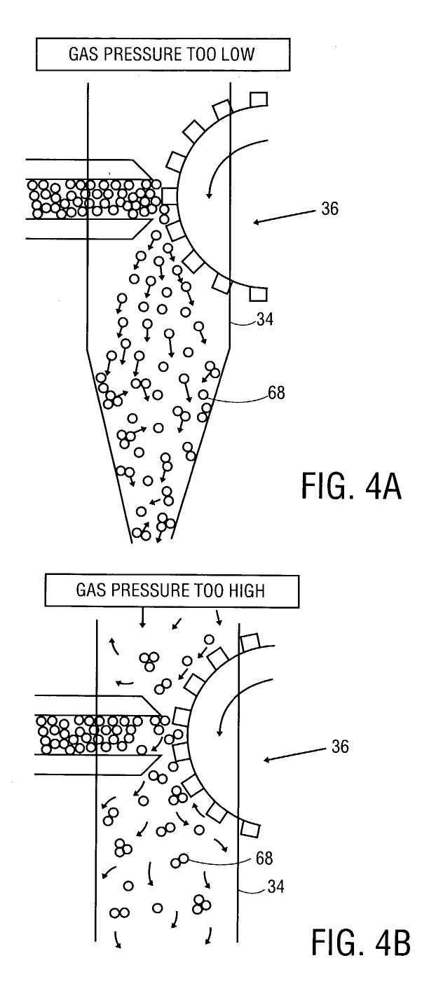

Referring again to FIG. 1, the vacuum pump 62 is simultaneously operated and the valve 56 is opened so that the carrier gas from the supply 26 is pumped through the deagglomeration chamber 34 into the vacuum chamber 58, and thereafter through the vacuum pump 62. The valve 56 and the pump 62 can be adjusted to create a desired pressure and flow rate within the deagglomeration chamber 34. The pressure within the deagglomeration chamber 34 is typically between 0.05 and 0.5 Torr, and the gas flow is preferably laminar. Such a pressure and flow causes coupling of the particles 68 (or units of particles) to the gas, and “entrains” the particles 68 so that they flow together with the gas through the deagglomeration chamber 34. When the pressure within the deagglomeration chamber 34 is too low, the particles do not couple to the gas and re-agglomerate on surfaces of the deagglomeration chamber 34, as illustrated in FIG. 4A. A pressure that is too high creates turbulent flow within the deagglomeration chamber 34 and the particles to become entrained in the turbulent gas flow, which can also lead to re-agglomeration as illustrated in FIG. 4B.

Referring again to FIG. 1, the particles 68 subsequently leave the deagglomeration chamber 34 through the outlet nozzle 42 together with the gas. The majority of the gas is pumped through the vacuum chamber 58, the vacuum pipe 60, and the vacuum pump 62 out of the system. The particles 68, due to their momentum, substantially maintain their direction of travel and pass through the orifice 64 into the skimmer 30. The majority of the gas is thus de-coupled from the particles 68. The gas is thus used to entrain and cause directional flow of the particles 68, but is then removed for purposes of creating a desired pressure around the particles 68 in the coating system 32. The pressure within the vacuum chamber 58 is preferably below 50 mTorr in order to ensure sufficient de-coupling of the particles 64 from the gas, so as to prevent the particles 64 from remaining entrained in the gas while passing through the skimmer 30.

The coating system 32 includes a coating chamber 72, an ablation target 74, and a pulsed high-power laser 76.

The coating chamber 72 has an upper wall with an opening 78 therein. A lower portion 30B of the skimmer 30 is inserted through the opening 78 into the coating chamber 72. The coating chamber 72 includes a main body 80 and a window 82. The main body 80 and the window 82 jointly form an internal volume 84 of the coating chamber 72.

The ablation target 74 is mounted to the main body 80 and has a side surface 86 exposed to the internal volume 84. The ablation target 74 is located on a side of the internal volume 84 opposing the window 82. The laser 76 is located externally of the coating chamber 72, and is oriented such that a laser beam 90 thereof is directed through the window 82 onto the surface 86 of the ablation target 74. The laser 76 may, for example, be an ultraviolet Eximer laser, and the ablation target 74 may be a metal, an insulator, a semiconductor, another material, or a combination of such materials.

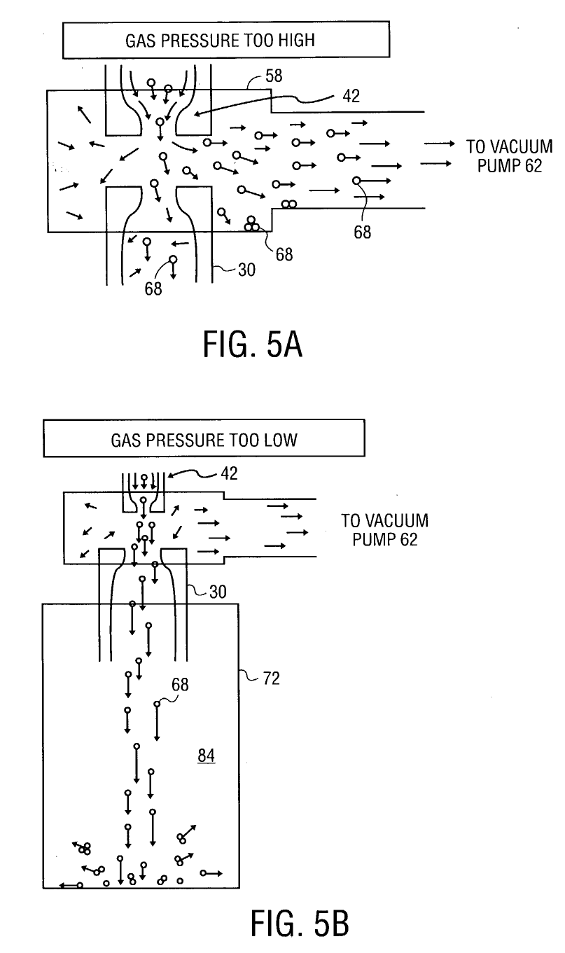

The length and diameter of the skimmer 30 is chosen to create a desired pressure in the internal volume 84. The skimmer 30 serves as a reduced conductance path between the outlet nozzle 42 and the wider internal volume 84. The conductance of the skimmer 30 determines the pressure in the internal volume 84 and therefore also the velocity of the particles 68 in the internal volume 84. A high skimmer conductance (e.g., a large diameter and/or a short length) will result is a low pressure in the coating chamber, whereas a low skimmer conductance (e.g., small diameter, longer length) will result in higher pressures in the internal volume 84. As illustrated in FIG. 5A, a pressure within the vacuum chamber 58 which is too high will cause particles emerging from the outlet nozzle 42 to remain entrained in the gas flow, which will result in a significant fraction to be collected in the vacuum chamber 58 and be pumped away by the vacuum pump 62. However, as illustrated in FIG. 5B, a pressure within the internal volume 84 which is too low will cause particles emerging from the outlet nozzle 42 to enter the coating chamber at too high of a velocity, because the pressure is too low to slow the particles down. The particles will thus not reach terminal velocity, as may be the case at a slightly higher pressure. The pressure of the internal volume 84 is typically more than 50 mTorr in FIG. 5A and typically less than one mTorr in FIG. 5B.

Referring again to FIG. 1, the cloud of particles 68 falls slowly through the internal volume 84. The laser 76 simultaneously creates a laser beam 90 that radiates through the window 82 and onto the surface 86 of the ablation target 74. The laser beam 90 ablates the ablation target 74 so that a plume of ablated atoms 92 emanate from a location where the laser beam 90 strikes the surface 86. The atoms 92 travel transversely to a direction in which the particles 68 fall through the internal volume 84. Some of the atoms 92 come into contact with the particles 68. The particles 68 are so coated with a thin layer of the material of the ablation target 74.

The coated particles subsequently drift down onto a base 94 of the coating chamber 72. The base 94 catches and collects the coated particles 68, from where they can be removed for further processing.

It can thus be seen that agglomerated particles 68 provided through the powder feed system 22 are broken into tiny units that are individually coated by first breaking the relatively high bonding energy that keeps these relatively small particles together, entraining the deagglomerated particles in a stream of gas, de-coupling the particles from the gas, and then coating the particles under controlled conditions. Such an apparatus and method may, for example, find application in the manufacture of specialty superconductors, batteries, or materials.

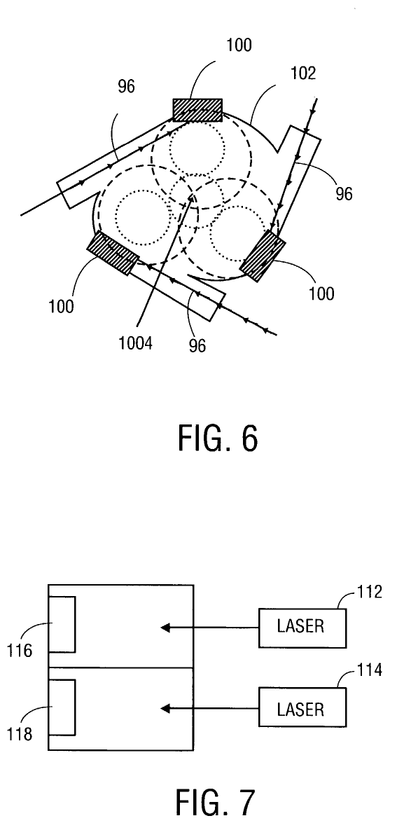

FIG. 6 illustrates another method of creating coated particles using pulsed laser for purposes of ablating targets. In the embodiment of FIG. 6, three laser beams 96 are directed at angles of 120° relative to one another through three respective windows 98. Each laser beam 96 ablates a respective target 100 at 120° angles around a coating chamber 102. A more uniform plume is created by atoms emanating from targets 100, through which the particles fall.

FIG. 7 illustrates a further embodiment having two lasers 112 and 114 and two ablation targets 116 and 118. The ablation targets 116 and 118 may be made of the same or different materials. Each laser 112 and 114 ablates a respective target 116 or 118. Particles first fall through plumes created by material of the target 116 and then through a plume created by material of the target 118. As such, each particle may be coated with more than one layer of the same material, or be coated with subsequent layers of different materials.

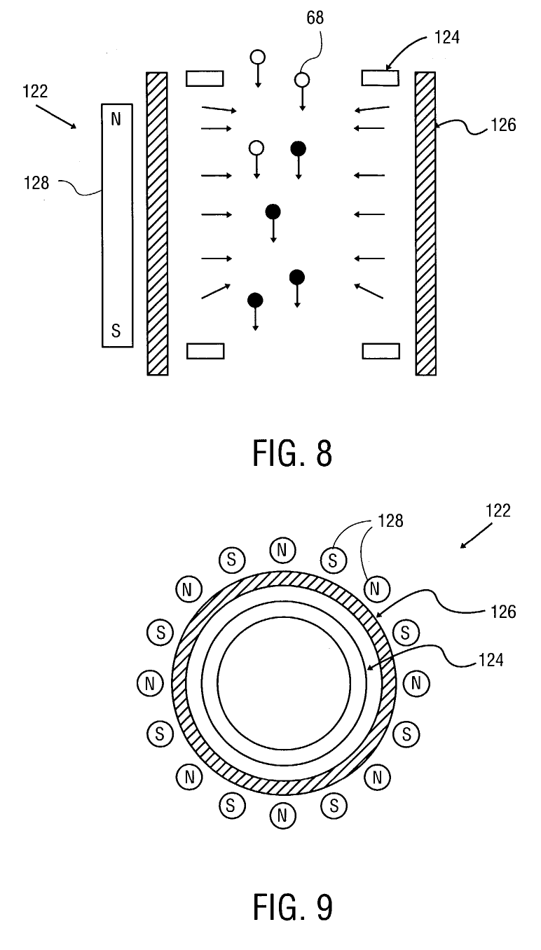

FIGS. 8 and 9 illustrate components of a coating system 122, according to a further embodiment of the invention. The coating system 122 is a cylindrical magnetron sputtering system, including a cylindrical anode 124, a cylindrical cathode 126 surrounding the cylindrical anode 124, and a plurality of magnets 128 surrounding the cathode 126. The components 124, 126, and 128 are typically all located within a coating chamber. In use, argon ions (Ar⁺) are introduced into the coating chamber at a desired pressure and collide with the cathode 126, serving as a target. Atoms are released from the cathode 126 and collide with and coat the particles 68.

It is important in this design to keep the deagglomerated particles 68 separate from the argon plasma used to sputter the neutral atoms of the cathode 126. Since the mobility of the electrons (e⁻) is much greater than that of the Ar⁺, any particle that encounters the plasma will encounter a negative charge. The resulting Coulomb repulsion between the particles can be large enough to deflect the majority of the particles from the path through the cylinder. A solution is to use a large enough cylindrical magnetron such that the only species that the particles encounter would be the neutral atoms emanating from the cathode 126.

An advantage of the coating system 122 is that atoms are released from the cathode 126 with very high “throwing power,” i.e., irregular surfaces can be coated efficiently. A further advantage is that a wide variety of materials can be used as targets. A disadvantage is that a pressure within the coating chamber of the system 122 has to be maintained at a level suitable for the argon ions to collide with the cathode 126 at a required impact speed and rate, and that such pressures are generally fairly low, typically around one mTorr. The coating system 32 of FIG. 1, by contrast, can be maintained at a higher pressure, typically at least 10 mTorr, which causes slower dropping of the particles 68 and more effective coating.

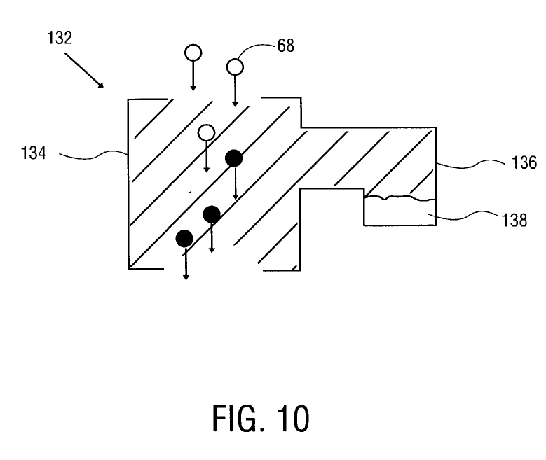

FIG. 10 illustrates a further coating system 132 that may be employed. The coating system 132 includes a coating chamber 134 and an evaporation unit 136. A molten metal 138 is held in the evaporation unit 136. Evaporated metal emanating from the molten metal 138 flows into the coating chamber 134 and comes into contact with the particles 68 to coat the particles 68.

Evaporation coating of particles requires pressures of less than one mTorr, and typically lower than 0.1 mTorr. Such low pressures are usually required in order to create a sufficiently high vapor pressure from a material that is being resistively heated. Evaporation coating does, however, have the advantage of not using any charged species that may result in deflection of particles that are being coated.

A further possibility is to use a chemical vapor deposition (CVD) coating system. In CVD, a metal complex is decomposed in a chamber containing the material to be coated. The process deposits atoms of the metal onto all available surfaces and thus can effectively coat high-surface-area materials such as powders. CVD is limited by the unavailability of high-vapor-pressure metal complexes that react readily to deposit a metal, and also by the potential for detrimental reaction with the material to be coated.

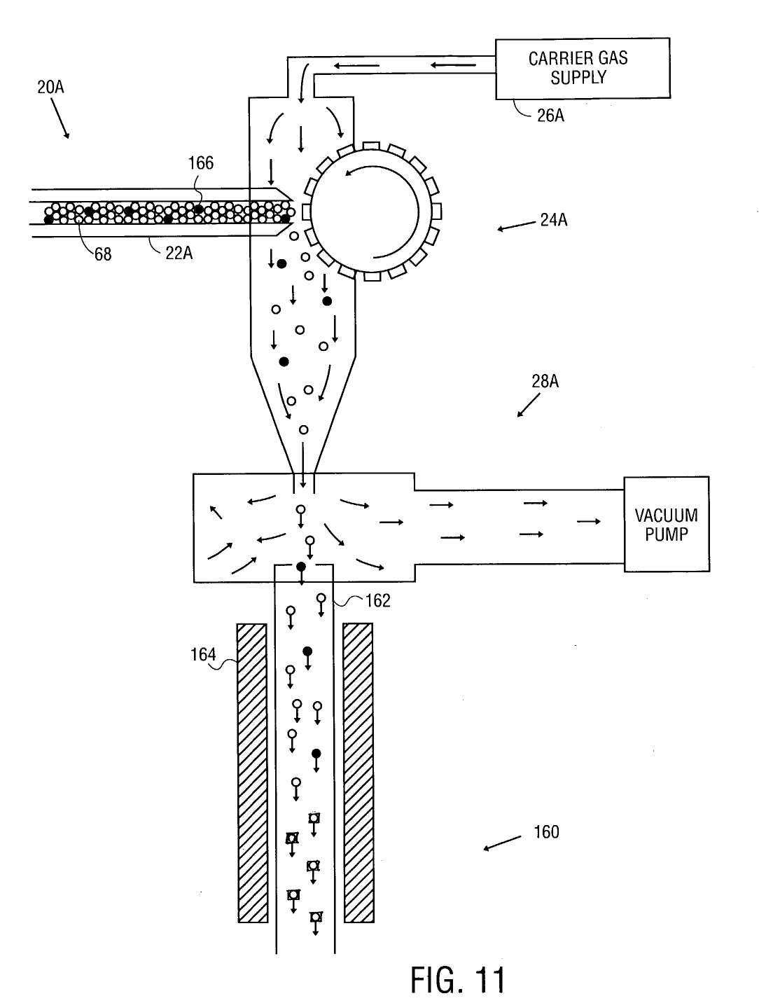

FIG. 11 illustrates an apparatus 20A, according to an alternative embodiment of the invention. In the apparatus 20A, the source used for coating the deagglomerated particles is mixed and fed together with the particles into the apparatus 20A.

Apparatus 20A, as with the apparatus 20 of FIG. 1, includes a powder feed system 22A, a deagglomerator 24A, a carrier gas supply 26A, and a vacuum system 28A. The apparatus 20A includes a different coating system 160 than the coating system 32 of FIG. 1. A longer skimmer 162 is provided that serves the dual purpose of a skimmer and a coating chamber. In the given example, a reactor in the form of a resistive heater 164 surrounds the skimmer 162, and forms part of the coating system 160.

Particles 68 that have to be coated are mixed with and fed together with source particles 166 through the powder feed system 22A (the particles that have to be coated are indicated with empty circles, and source particles are indicated with darkened circles).

The source particles 166 are deagglomerated together with the particles 68 that have to be coated, and pass through the deagglomerator 24A and into the skimmer 162 together with the particles 68 that have to be coated. Both types of particles reach terminal velocity slightly above the resistive heater 164 and then fall slowly through the skimmer 162. Heat radiated by the resistive heater 164 increases the temperature of the particles 68 and 166. The particles 166 decompose fast and the particles 68 do not decompose. When the particles 166 decompose, they form a plume of atoms around the particles 68, and the atoms then form layers on the particles 68. (Coated particles are indicated with squares with circles in them.) In the present example, decomposition of the particles 166 is thermally induced, although it should be understood that another reactor may utilize another mechanism for decomposing source particles, such as photo-induced decomposition. The apparatus 20A of FIG. 11 is the same as the apparatus 20 of FIG. 1 in all other respects.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

What is claimed:

1. A method of forming coated units, comprising:
overcoming a bonding energy between agglomerated particles to separate the particles into deagglomerated units, each unit having one or more particles and at least 50% of the units having widths of less than 10 microns;
forming a layer on at least some of the deagglomerated units to form a plurality of coated units; and
capturing the coated units.

2. The method of claim 1, wherein the bonding energy is overcome by impact against a surface traveling relatively toward the agglomerated particles.

3. The method of claim 2, wherein the surface travels relatively toward the agglomerated particles at a velocity of at least 1 m/s.

4. The method of claim 2, wherein the surface is a surface on a component traveling in a closed loop path.

5. The method of claim 4, further comprising:
feeding the agglomerated particles to the surface so that successive amounts of the agglomerated particles are struck by the surface upon successive revolutions of the component.

6. The method of claim 1, wherein the particles have widths of less than 5 microns.

7. The method of claim 1, further comprising:
introducing the deagglomerated units into a gas, the gas having a select pressure such that the deagglomerated units couple to the gas and travel with the gas in a select direction; and
pumping the gas in a direction other than a direction in which the deagglomerated units travel to de-couple the deagglomerated units from a majority of the gas before forming the layers on the deagglomerated units.

8. The method of claim 7, wherein the pressure of the gas is sufficiently low such that less than 10% of the deagglomerated units re-agglomerate before the gas is de-coupled from the deagglomerated units.

9. The method of claim 8, wherein the pressure is between 0.05 and 0.5 Torr.

10. The method of claim 7, wherein the flow of the gas is laminar.

11. The method of claim 7, wherein a pressure of gas surrounding the deagglomerated units is between 0.001 and 0.1 Torr after the deagglomerated units are de-coupled from the gas.

12. The method of claim 7, further comprising:
allowing the deagglomerated units to travel through a skimmer; and
allowing the deagglomerated units to travel from the skimmer into a coating chamber, the skimmer having a small width compared with the coating chamber which, in combination with a length of the skimmer, control a pressure in the coating chamber.

13. The method of claim 1, wherein the deagglomerated units are coated by a source of coating particles traveling transverse to a direction in which the deagglomerated units travel.

14. The method of claim 13, further comprising:
directing a laser beam onto an ablation target, ablated coating particles being released from the ablation target and traveling from the ablation target onto the deagglomerated units.

15. The method of claim 14, wherein the deagglomerated units are coated with the layers in a coating chamber which is at least partially formed by a window, and the laser beam is directed through the window into the coating chamber and onto the ablation target.

16. A method of forming coated units, comprising:
overcoming a bonding energy between agglomerated particles to separate the particles into deagglomerated units, each unit having one or more particles;
directing a laser beam onto an ablation target, ablated coating particles being released from the ablation target and traveling from the ablation target onto the deagglomerated units to form a plurality of coated units; and
capturing the coated units.

17. An apparatus for forming coated units, comprising:
means for overcoming a bonding energy between agglomerated particles to separate the particles into deagglomerated units, each unit having one or more particles and at least 50% of the units having widths of less than 10 microns;
means for forming a layer on at least some of the deagglomerated units to form a plurality of coated units; and
means for capturing the coated units.

18. An apparatus for forming a plurality of coated units, comprising:
a feed system capable of holding and feeding agglomerated particles to a deagglomeration location;
a component traveling in a closed loop path and having a surface that repeatedly strikes successive amounts of the agglomerated particles at the deagglomeration location to separate the particles into deagglomerated units, each unit having one or more particles;
a coating chamber where a layer is formed on at least some of the deagglomerated units to form a plurality of coated units; and
a device positioned to capture the coated units.

19. The apparatus of claim 18, further comprising:
a deagglomeration chamber having a gas inlet and a gas outlet; and
a vacuum device connected to the gas outlet, the deagglomerated units coupling to a gas traveling from the inlet to the outlet and de-coupling from the gas before the gas is pumped through the outlet and before being coated in the coating chamber.

20. The apparatus of claim 18, further comprising:
a source of coating particles, coating particles traveling from the source transverse to a direction in which the deagglomerated units travel and coating the deagglomerated units.
